(19) United States
(12) Patent Application Publication
(10) Pub. No.: US 2015/0084881 A1
(43) Pub. Date: Mar. 26, 2015

(54) DATA PROCESSING METHOD AND ELECTRONIC DEVICE

(71) Applicant: LENOVO (BEIJING) LIMITED, Beijing (CN)

(72) Inventor: Ling Yu, Beijing (CN)

(73) Assignee: LENOVO (BEIJING) LIMITED, Beijing (CN)

(21) Appl. No.: 14/230,750

(22) Filed: Mar. 31, 2014

(30) Foreign Application Priority Data
Sep. 25, 2013 (CN) 201310453068.0

(51) Int. Cl. G06F 1/16; G06T 3/60; G06F 3/041; G06F 3/01

(52) U.S. Cl. CPC G06F 1/1694; G06F 3/017; G06T 3/60; G06F 3/041
USPC 345/173

(57) ABSTRACT

The present invention provides a data processing method applied in an electronic device having a touch display unit for displaying a first image in a first display orientation. The method comprises: detecting a first rotation operation applied by an operator to adjust the display orientation of the first image from the first display orientation to a second display orientation different from the first display orientation; and controlling the display orientation of the first image to be adjusted from the first display orientation to the second display orientation in response to detecting the first rotation operation. An angle between the first display orientation and the second display orientation is an arbitrary angle other than 0°.

### TECHNICAL FIELD

The present invention relates to electronic technology, and more particularly, to a data processing method and an electronic device.

### BACKGROUND

With the continuous growth of applications of multi-media technology, portable multi-media playing devices, such as mobile phones and PADs, are becoming increasingly popular in people's lives and works. Currently, the portable multi-media playing devices are equipped with display screens for displaying interfaces.

In order to allow a portable multi-media playing device to be portable, it typically has a small dimension, which in turn restricts the dimension of its display screen to be small as well. Hence, in order to take full advantage of the display screen when displaying an image, it is desired that the image can be displayed in a landscape orientation when the multi-media playing device is placed in the landscape orientation or in a portrait orientation when the multi-media playing device is placed in the portrait orientation.

However, the inventors have found at least the following problem with the conventional method during the implementation of the present invention. In operation, an image can only be displayed in the landscape or the portrait orientation. In other words, the image can only be rotated by a multiple of 90° even if it is desired to rotate it by another angle.

### SUMMARY

It is an object of the present invention to provide a data processing method and an electronic device, capable of solving the above problem in the conventional method that an image can only be rotated by a multiple of 90° even if it is desired to rotate it by another angle, thereby achieving a technical effect of allowing an image to be rotated by an arbitrary angle.

According to an embodiment of the present invention, a data processing method is provided. The data processing method is applied in an electronic device having a touch display unit for displaying a first image in a first display orientation. The method comprises: detecting a first rotation operation applied by an operator to adjust the display orientation of the first image from the first display orientation to a second display orientation different from the first display orientation. The first rotation operation is a rotation operation applied by the operator on the touch display unit or a rotation operation for rotating the electronic device from a first gesture corresponding to the first display orientation to a second gesture corresponding to the second display orientation. The method further comprises: controlling the display orientation of the first image to be adjusted from the first display orientation to the second display orientation in response to detecting the first rotation operation. An angle between the first display orientation and the second display orientation is an arbitrary angle other than 0°.

Preferably, when the first rotation operation is a rotation operation for rotating the electronic device from a first gesture corresponding to the first display orientation to a second gesture corresponding to the second display orientation, said detecting a first rotation operation applied by an operator to adjust the display orientation of the first image from the first display orientation to a second display orientation different from the first display orientation comprises: determining whether the electronic device has been rotated from the first gesture to the second gesture to obtain a determination result. The first rotation operation is detected when the determination result indicates that the electronic device has been rotated from the first gesture to the second gesture.

Preferably, the method further comprises, subsequent to said determining whether the electronic device has been rotated from the first gesture to the second gesture to obtain a determination result: detecting a first position relationship between the first gesture and the second gesture when the determination result indicates that the electronic device has been rotated from the first gesture to the second gesture.

Preferably, said detecting a first position relationship between the first gesture and the second gesture comprises: detecting a first angle or a first displacement between the first gesture and the second gesture.

Preferably, when the first angle is a degree, said controlling the display orientation of the first image to be adjusted from the first display orientation to the second display orientation in response to detecting the first rotation operation comprises: generating a rotation instruction for rotating the first image by −α degree upon detecting that the electronic device has been rotated from the first gesture to the second gesture; and executing the rotation instruction to control the display orientation of the first image to be rotated by −α degree from the first display orientation to the second display orientation.

Preferably, when the first rotation operation is a rotation operation applied by the operator on the touch display unit, said detecting a first rotation operation applied by an operator to adjust the display orientation of the first image from the first display orientation to a second display orientation different from the first display orientation comprises: detecting whether a contact region between the operator and the touch display unit has been rotated on the touch display unit from a first position to a second position different from the first position to obtain a detection result, and determining whether the first rotation operation has been applied based on the detection result.

Preferably, said detecting whether a contact region between the operator and the touch display unit has been rotated on the touch display unit from a first position to a second position different from the first position to obtain a detection result comprises: detecting whether an identification area of the contact region has been rotated on the touch display unit from a third position corresponding to the first position to a fourth position corresponding to the second position and different from the third position.

Preferably, said detecting whether a contact region between the operator and the touch display unit has been rotated on the touch display unit from a first position to a second position different from the first position to obtain a detection result comprises: detecting whether a first reference line and a second reference line that does not coincide with the first reference line of the contact region have been rotated on the touch display unit from a fifth position corresponding to the first position to a sixth position corresponding to the second position and different from the fifth position.

Preferably, said detecting whether a first reference line and a second reference line that does not coincide with the first reference line of the contact region have been rotated on the touch display unit from a fifth position corresponding to the first position to a sixth position corresponding to the second position and different from the fifth position comprises: detecting whether the first reference line and the second reference line orthogonal to the first reference line of the contact region between the operator and the touch display unit have been rotated on the touch display unit from the fifth position to the sixth position.

According to another embodiment of the present invention, an electronic device is provided. The electronic device comprises a touch display unit for displaying a first image in a first display orientation. The electronic device further comprises: a detection unit configured to detect a first rotation operation applied by an operator to adjust the display orientation of the first image from the first display orientation to a second display orientation different from the first display orientation. An angle between the first display orientation and the second display orientation is an arbitrary angle other than 0°. The electronic device further comprises: a control unit configured to control the display orientation of the first image to be adjusted from the first display orientation to the second display orientation in response to detecting the first rotation operation. The first rotation operation is a rotation operation applied by the operator on the touch display unit or a rotation operation for rotating the electronic device from a first gesture corresponding to the first display orientation to a second gesture corresponding to the second display orientation.

Preferably, the detection unit comprises: a determination unit configured to determine whether the electronic device has been rotated from the first gesture to the second gesture to obtain a determination result. The first rotation operation is detected when the determination result indicates that the electronic device has been rotated from the first gesture to the second gesture.

Preferably, the detection unit further comprises: a detection sub-unit configured to detect a first position relationship between the first gesture and the second gesture when the determination result indicates that the electronic device has been rotated from the first gesture to the second gesture.

Preferably, the first position relationship is a first angle or a first displacement.

Preferably, the control unit comprises: a generation unit configured to generate, when the first angle is a degree, a rotation instruction for rotating the first image by −α degree upon detecting that the electronic device has been rotated from the first gesture to the second gesture; and an executing unit configured to execute the rotation instruction to control the display orientation of the first image to be rotated by −α degree from the first display orientation to the second display orientation.

Preferably, the detection unit is configured to detect whether a contact region between the operator and the touch display unit has been rotated on the touch display unit from a first position to a second position different from the first position to obtain a detection result.

Preferably, an identification area is provided in the contact region. As the contact region is rotated from the first position to the second position, the identification area is rotated from a third position corresponding to the first position to a fourth position corresponding to the second position and different from the third position.

Preferably, the contact region has a first reference line and a second reference line that does not coincide with the first reference line. As the contact region is rotated from the first position to the second position, the first reference line and the second reference line are rotated from a fifth position corresponding to the first position to a sixth position corresponding to the second position and different from the fifth position.

Preferably, the first reference line is orthogonal to the second reference line.

Preferably, the detection unit is an angle sensor or a displacement sensor.

Preferably, the angle sensor is a gyroscope or a gravity sensor.

The present invention has the following advantageous effect.

With the above data processing method, the first image can be processed when the angle between the first display orientation and the second display orientation is an arbitrary angle other than 0°. Thus, the data processing method is capable of solving the above problem in the conventional method that an image can only be rotated by a multiple of 90° even if it is desired to rotate it by another angle, thereby achieving a technical effect of allowing an image to be rotated by an arbitrary angle.

When the electronic device has been rotated, the first image is controlled to be rotated in a direction opposite to the direction of the first rotation operation applied to the electronic device. In this way, it is possible to ensure that the first image can be displayed vertically after the electronic device has been rotated by an arbitrary angle.

The first image can be rotated as the contact region is rotated in response to the operation applied by the operator on the touch display unit. In this way, when the electronic device is placed in the portrait or landscape orientation, the first image can be rotated to any angle relative to the electronic device, so as to satisfy different user requirements.

### BRIEF DESCRIPTION OF THE DRAWINGS

FIG. 1 is a flowchart illustrating a data processing method according to a first preferred embodiment of the present invention;

FIG. 2 is a schematic diagram showing an electronic device having a first gesture in the data processing method of FIG. 1;

FIG. 3 is a schematic diagram showing the electronic device of FIG. 2 having a second gesture;

FIG. 4 is a schematic diagram showing an electronic device being touched by an operator in the data processing method of FIG. 1; and

FIG. 5 is a schematic diagram showing the electronic device of FIG. 4 after being rotated by the operator.

### DETAILED DESCRIPTION OF THE EMBODIMENTS

The embodiments of the present invention provide a data processing method and an electronic device, capable of solving the above problem in the conventional method that an image can only be rotated by a multiple of 90° even if it is desired to rotate it by another angle, thereby achieving a technical effect of allowing an image to be rotated by an arbitrary angle.

The general concept of the solutions according to the embodiments of the present invention for solving the above problem in the conventional method that an image can only be rotated by a multiple of 90° even if it is desired to rotate it by another angle will be described below.

A data processing method is provided. The data processing method is applied in an electronic device having a touch display unit for displaying a first image in a first display orientation. The method comprises: detecting a first rotation operation applied by an operator to adjust the display orientation of the first image from the first display orientation to a second display orientation different from the first display orientation. The first rotation operation is a rotation operation applied by the operator on the touch display unit or a rotation operation for rotating the electronic device from a first gesture corresponding to the first display orientation to a second gesture corresponding to the second display orientation. The method further comprises: controlling the display orientation of the first image to be adjusted from the first display orientation to the second display orientation in response to detecting the first rotation operation. An angle between the first display orientation and the second display orientation is an arbitrary angle other than 0°.

Also provided is an electronic device. The electronic device comprises a touch display unit for displaying a first image in a first display orientation. The electronic device further comprises: a detection unit configured to detect a first rotation operation applied by an operator to adjust the display orientation of the first image from the first display orientation to a second display orientation different from the first display orientation. An angle between the first display orientation and the second display orientation is an arbitrary angle other than 0°. The electronic device further comprises: a control unit configured to control the display orientation of the first image to be adjusted from the first display orientation to the second display orientation in response to detecting the first rotation operation. The first rotation operation is a rotation operation applied by the operator on the touch display unit or a rotation operation for rotating the electronic device from a first gesture corresponding to the first display orientation to a second gesture corresponding to the second display orientation.

With the above data processing method, the first image can be processed when the angle between the first display orientation and the second display orientation is an arbitrary angle other than 0°. Thus, the data processing method is capable of solving the above problem in the conventional method that an image can only be rotated by a multiple of 90° even if it is desired to rotate it by another angle, thereby achieving a technical effect of allowing an image to be rotated by an arbitrary angle.

The above solutions will be described in detail with reference to the figures and embodiments, such that the above solutions will become more apparent.

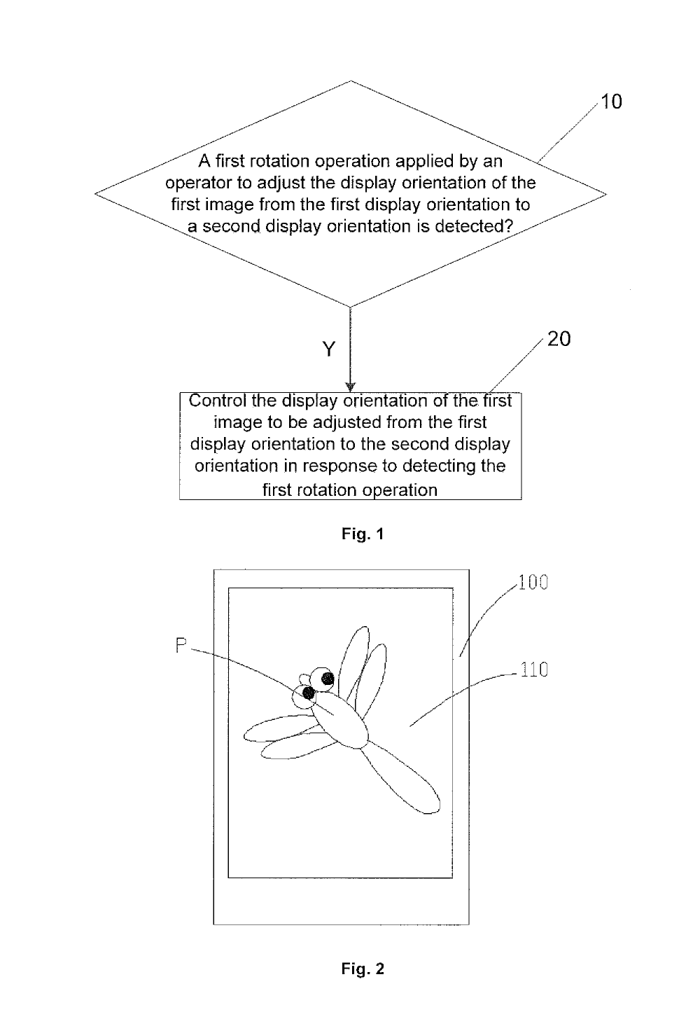

Reference is now made to FIG. 1, which is a flowchart illustrating a data processing method according to a first preferred embodiment of the present invention. The data processing method is applied in an electronic device 100.

Referring to FIG. 2, the electronic device 100 includes a touch display unit 110 for displaying a first image P in a first display orientation.

The method may include the following steps.

At step 10, a first rotation operation applied by an operator is detected. The first rotation operation is to adjust the display orientation of the first image P from the first display orientation to a second display orientation different from the first display orientation.

Each of the first and second display orientations is a display orientation of the first image P relative to the electronic device 100. For example, when the electronic device 100 is placed vertically, the first image P will be displayed vertically, i.e., the first display orientation will be 0°.

Here, the first rotation operation is a rotation operation applied by the operator on the touch display unit or a rotation operation for rotating the electronic device from a first gesture corresponding to the first display orientation to a second gesture corresponding to the second display orientation.

At step 20, the display orientation of the first image P is controlled to be adjusted from the first display orientation to the second display orientation in response to detecting the first rotation operation. Here, an angle between the first display orientation and the second display orientation is an arbitrary angle other than 0°.

With the above data processing method, the first image can be processed when the angle between the first display orientation and the second display orientation is an arbitrary angle other than 0°. Thus, the data processing method is capable of solving the above problem in the conventional method that an image can only be rotated by a multiple of 90° even if it is desired to rotate it by another angle, thereby achieving a technical effect of allowing an image to be rotated by an arbitrary angle.

In particular, there can be two schemes for the operator to perform the first rotation operation. Each of two schemes for performing the first rotation operation will be described below.

In the first scheme, the display orientation of the first image P can be adjusted from the first display orientation to the second display orientation by rotating the electronic device 100.

In particular, when the first rotation operation is a rotation operation for rotating the electronic device 100 from a first gesture corresponding to the first display orientation to a second gesture corresponding to the second display orientation, the step of detecting a first rotation operation applied by an operator to adjust the display orientation of the first image P from the first display orientation to a second display orientation different from the first display orientation includes determining whether the electronic device has been rotated from the first gesture to the second gesture to obtain a determination result. The first rotation operation is detected when the determination result indicates that the electronic device has been rotated from the first gesture to the second gesture.

In particular, the method further includes: subsequent to the step of determining whether the electronic device 100 has been rotated from the first gesture to the second gesture to obtain a determination result: detecting a first position relationship between the first gesture and the second gesture when the determination result indicates that the electronic device has been rotated from the first gesture to the second gesture.

In particular, the step of detecting a first position relationship between the first gesture and the second gesture includes: detecting a first angle or a first displacement between the first gesture and the second gesture.

In particular, when the first angle is a degree, the step of controlling the display orientation of the first image P to be adjusted from the first display orientation to the second display orientation in response to detecting the first rotation operation includes: generating a rotation instruction for rotating the first image P by −α degree upon detecting that the electronic device has been rotated from the first gesture to the second gesture; and executing the rotation instruction to control the display orientation of the first image P to be rotated by −α degree from the first display orientation to the second display orientation.

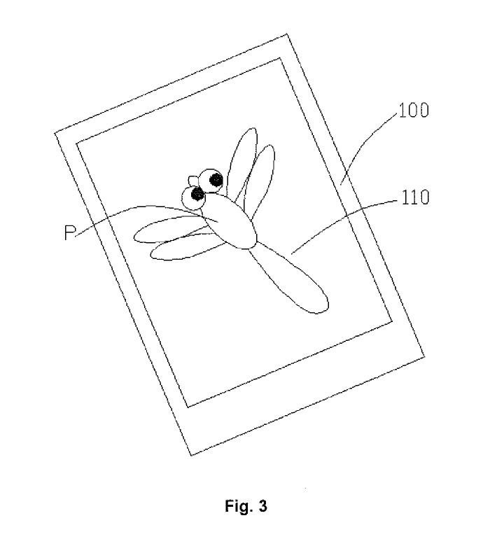

In an embodiment, as shown in FIG. 2 and FIG. 3, it is assumed that the operator is User U, the current first gesture of the electronic device 100 is a portrait mode having an orientation of 90°, and the touch display unit 110 of the electronic device 100 displays the first image P in the first display orientation of 0°, which is a relative position of the first image P relative to the electronic device 100.

When User U rotates the electronic device 100 to e.g., a second gesture having an orientation of 120°, it is determined that the angle by which the electronic device 100 is rotated is 30° counterclockwise upon detecting the operation for rotating the electronic device 100. In this case, as the electronic device 100 is rotated, the first image P is rotated to a display orientation of 120°. In response to the rotation operation, the first image P is controlled to be rotated by 30° clockwise back to the vertical display orientation.

The above assumptions of angles and orientations are provided only for the purpose of illustrating this solution clearly, rather than limiting the solution to the angles and orientations.

When the electronic device 100 has been rotated, the first image P is controlled to be rotated in a direction opposite to the direction of the first rotation operation applied to the electronic device 100. In this way, it is possible to ensure that the first image P can be displayed vertically after the electronic device 100 has been rotated by an arbitrary angle.

In the second scheme, the operator can perform a rotation operation on the touch display unit to adjust the display orientation of the first image P from the first display orientation to the second display orientation.

In particular, when the first rotation operation is a rotation operation applied by the operator on the touch display unit, the step of detecting a first rotation operation applied by an operator to adjust the display orientation of the first image P from the first display orientation to a second display orientation different from the first display orientation includes: detecting whether a contact region A between the operator and the touch display unit has been rotated on the touch display unit from a first position to a second position different from the first position to obtain a detection result, and determining whether the first rotation operation has been applied based on the detection result.

In particular, the step of detecting whether a contact region A between the operator and the touch display unit has been rotated on the touch display unit from a first position to a second position different from the first position to obtain a detection result includes: detecting whether an identification area of the contact region A has been rotated on the touch display unit from a third position corresponding to the first position to a fourth position corresponding to the second position and different from the third position.

In particular, the step of detecting whether a contact region A between the operator and the touch display unit has been rotated on the touch display unit from a first position to a second position different from the first position to obtain a detection result includes: detecting whether a first reference line L1 and a second reference line L2 that does not coincide with the first reference line L1 of the contact region A have been rotated on the touch display unit from a fifth position corresponding to the first position to a sixth position corresponding to the second position and different from the fifth position.

In particular, the step of detecting whether a first reference line L1 and a second reference line L2 that does not coincide with the first reference line L2 of the contact region A have been rotated on the touch display unit from a fifth position corresponding to the first position to a sixth position corresponding to the second position and different from the fifth position includes: detecting whether the first reference line L1 and the second reference line L2 orthogonal to the first reference line L1 of the contact region A between the operator and the touch display unit have been rotated on the touch display unit from the fifth position to the sixth position.

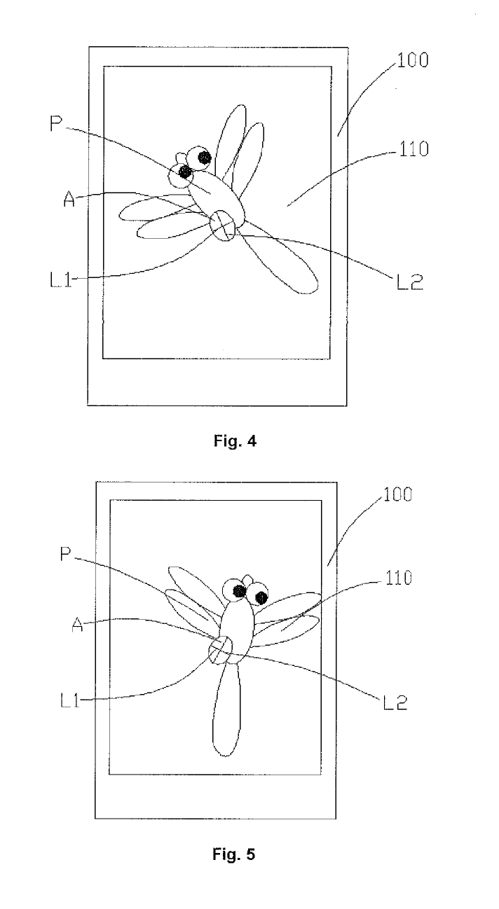

In an embodiment, as shown in FIG. 4 and FIG. 5, it is assumed that the operator is User U, the current first gesture of the electronic device 100 is a portrait mode, and the touch display unit 110 of the electronic device 100 displays the first image P in the first display orientation of 0°, which is a relative position of the first image P relative to the electronic device 100.

When User U places his/her finger on the touch display unit 110 of the electronic device 100 and rotates the finger, the rotation operation in the contact region A between the finger and the touch display unit 110 is detected. For example, the finger can be rotated by 30° and in this case the display orientation of the first image P can be rotated by 30° from the first display orientation to the second display orientation. In particular, the rotation operation in the contact region A can be detected by detecting two reference lines of the contact region A, a mark in the contact region A or fingerprint information.

The first image P can be rotated as the contact region A is rotated in response to the operation applied by the operator on the touch display unit 110. In this way, when the electronic device is placed in the portrait or landscape orientation, the first image P can be rotated to any angle relative to the electronic device, so as to satisfy different user requirements.

An electronic device 100 corresponding to the above data processing method includes a touch display unit for displaying a first image P in a first display orientation.

The electronic device further includes a detection unit configured to detect a first rotation operation applied by an operator to adjust the display orientation of the first image from the first display orientation to a second display orientation different from the first display orientation. An angle between the first display orientation and the second display orientation is an arbitrary angle other than 0°.

The electronic device further includes a control unit configured to control the display orientation of the first image P to be adjusted from the first display orientation to the second display orientation in response to detecting the first rotation operation.

The first rotation operation is a rotation operation applied by the operator on the touch display unit or a rotation operation for rotating the electronic device from a first gesture corresponding to the first display orientation to a second gesture corresponding to the second display orientation.

In particular, the detection unit includes: a determination unit configured to determine whether the electronic device has been rotated from the first gesture to the second gesture to obtain a determination result. The first rotation operation is detected when the determination result indicates that the electronic device has been rotated from the first gesture to the second gesture.

In particular, the detection unit further includes: a detection sub-unit configured to detect a first position relationship between the first gesture and the second gesture when the determination result indicates that the electronic device has been rotated from the first gesture to the second gesture.

In particular, the first position relationship is a first angle or a first displacement.

In particular, the control unit includes: a generation unit configured to generate, when the first angle is a degree, a rotation instruction for rotating the first image P by −α degree upon detecting that the electronic device has been rotated from the first gesture to the second gesture; and an executing unit configured to execute the rotation instruction to control the display orientation of the first image P to be rotated by −α degree from the first display orientation to the second display orientation.

In particular, the detection unit is configured to detect whether a contact region A between the operator and the touch display unit has been rotated on the touch display unit from a first position to a second position different from the first position to obtain a detection result.

In particular, an identification area is provided in the contact region A. As the contact region A is rotated from the first position to the second position, the identification area is rotated from a third position corresponding to the first position to a fourth position corresponding to the second position and different from the third position.

In particular, the contact region A has a first reference line L1 and a second reference line L2 that does not coincide with the first reference line L1. As the contact region A is rotated from the first position to the second position, the first reference line L1 and the second reference line L2 are rotated from a fifth position corresponding to the first position to a sixth position corresponding to the second position and different from the fifth position.

Preferably, the first reference line L1 is orthogonal to the second reference line L2.

Preferably, the detection unit is an angle sensor or a displacement sensor.

Preferably, the angle sensor is a gyroscope or a gravity sensor.

With the above data processing method, the first image can be processed when the angle between the first display orientation and the second display orientation is an arbitrary angle other than 0°. Thus, the data processing method is capable of solving the above problem in the conventional method that an image can only be rotated by a multiple of 90° even if it is desired to rotate it by another angle, thereby achieving a technical effect of allowing an image to be rotated by an arbitrary angle.

When the electronic device 100 has been rotated, the first image P is controlled to be rotated in a direction opposite to the direction of the first rotation operation applied to the electronic device 100. In this way, it is possible to ensure that the first image P can be displayed vertically after the electronic device 100 has been rotated by an arbitrary angle.

The first image P can be rotated as the contact region A is rotated in response to the operation applied by the operator on the touch display unit 110. In this way, when the electronic device is placed in the portrait or landscape orientation, the first image P can be rotated to any angle relative to the electronic device, so as to satisfy different user requirements.

While the preferred embodiments of the present invention have been described above, further modifications and alternatives can be made to these embodiments by those skilled in the art based on the teaching of the present invention. Therefore, the preferred embodiments as well as all these modifications and alternatives are to be encompassed by the scope of present invention defined by the claims as attached.

Obviously, various modifications and variants can be made to the present invention by those skilled in the art without departing from the spirit and scope of the present invention. Therefore, these modifications and variants are to be encompassed by the present invention if they fall within the scope of the present invention as defined by the claims and their equivalents.

What is claimed is:

1. A data processing method, applied in an electronic device having a touch display unit for displaying a first image in a first display orientation, the method comprising:
detecting a first rotation operation applied by an operator to adjust the display orientation of the first image from the first display orientation to a second display orientation different from the first display orientation, wherein the first rotation operation is a rotation operation applied by the operator on the touch display unit or a rotation operation for rotating the electronic device from a first gesture corresponding to the first display orientation to a second gesture corresponding to the second display orientation; and
controlling the display orientation of the first image to be adjusted from the first display orientation to the second display orientation in response to detecting the first rotation operation, wherein an angle between the first display orientation and the second display orientation is an arbitrary angle other than 0°.

2. The method of claim 1, wherein, when the first rotation operation is a rotation operation for rotating the electronic device from a first gesture corresponding to the first display orientation to a second gesture corresponding to the second display orientation, said detecting a first rotation operation applied by an operator to adjust the display orientation of the first image from the first display orientation to a second display orientation different from the first display orientation comprises:
determining whether the electronic device has been rotated from the first gesture to the second gesture to obtain a determination result,
wherein the first rotation operation is detected when the determination result indicates that the electronic device has been rotated from the first gesture to the second gesture.

3. The method of claim 2, further comprising, subsequent to said determining whether the electronic device has been rotated from the first gesture to the second gesture to obtain a determination result:
detecting a first position relationship between the first gesture and the second gesture when the determination result indicates that the electronic device has been rotated from the first gesture to the second gesture.

4. The method of claim 3, wherein said detecting a first position relationship between the first gesture and the second gesture comprises:
detecting a first angle or a first displacement between the first gesture and the second gesture.

5. The method of claim 4, wherein, when the first angle is a degree, said controlling the display orientation of the first image to be adjusted from the first display orientation to the second display orientation in response to detecting the first rotation operation comprises:
generating a rotation instruction for rotating the first image by −α degree upon detecting that the electronic device has been rotated from the first gesture to the second gesture; and
executing the rotation instruction to control the display orientation of the first image to be rotated by −α degree from the first display orientation to the second display orientation.

6. The method of claim 1, wherein, when the first rotation operation is a rotation operation applied by the operator on the touch display unit, said detecting a first rotation operation applied by an operator to adjust the display orientation of the first image from the first display orientation to a second display orientation different from the first display orientation comprises:
detecting whether a contact region between the operator and the touch display unit has been rotated on the touch display unit from a first position to a second position different from the first position to obtain a detection result, and
determining whether the first rotation operation has been applied based on the detection result.

7. The method of claim 6, wherein said detecting whether a contact region between the operator and the touch display unit has been rotated on the touch display unit from a first position to a second position different from the first position to obtain a detection result comprises:
detecting whether an identification area of the contact region has been rotated on the touch display unit from a third position corresponding to the first position to a fourth position corresponding to the second position and different from the third position.

8. The method of claim 6, wherein said detecting whether a contact region between the operator and the touch display unit has been rotated on the touch TO display unit from a first position to a second position different from the first position to obtain a detection result comprises:
detecting whether a first reference line and a second reference line that does not coincide with the first reference line of the contact region have been rotated on the touch display unit from a fifth position corresponding to the first position to a sixth position corresponding to the second position and different from the fifth position.

9. The method of claim 8, wherein said detecting whether a first reference line of the contact region and a second reference line that does not coincide with the first reference line of the contact region have been rotated on the touch display unit from a fifth position corresponding to the first position to a sixth position corresponding to the second position and different from the fifth position comprises:
detecting whether the first reference line and the second reference line orthogonal to the first reference line of the contact region between the operator and the touch display unit have been rotated on the touch display unit from the fifth position to the sixth position.

10. An electronic device, comprising a touch display unit for displaying a first image in a first display orientation and further comprising:
a detection unit configured to detect a first rotation operation applied by an operator to adjust the display orientation of the first image from the first display orientation to a second display orientation different from the first display orientation, wherein an angle between the first display orientation and the second display orientation is an arbitrary angle other than 0°; and
a control unit configured to control the display orientation of the first image to be adjusted from the first display orientation to the second display orientation in response to detecting the first rotation operation,
wherein the first rotation operation is a rotation operation applied by the operator on the touch display unit or a rotation operation for rotating the electronic device from a first gesture corresponding to the first display orientation to a second gesture corresponding to the second display orientation.

11. The electronic device of claim 10, wherein the detection unit comprises:
a determination unit configured to determine whether the electronic device has been rotated from the first gesture to the second gesture to obtain a determination result,
wherein the first rotation operation is detected when the determination result indicates that the electronic device has been rotated from the first gesture to the second gesture.

12. The electronic device of claim 11, wherein the detection unit further comprises:
a detection sub-unit configured to detect a first position relationship between the first gesture and the second gesture when the determination result indicates that the electronic device has been rotated from the first gesture to the second gesture.

13. The electronic device of claim 12, wherein the first position relationship is a first angle or a first displacement.

14. The electronic device of claim 13, wherein the control unit comprises:
a generation unit configured to generate, when the first angle is a degree, a rotation instruction for rotating the first image by −α degree upon detecting that the electronic device has been rotated from the first gesture to the second gesture; and
an executing unit configured to execute the rotation instruction to control the display orientation of the first image to be rotated by −α degree from the first display orientation to the second display orientation.

15. The electronic device of claim 10, wherein the detection unit is configured to detect whether a contact region between the operator and the touch display unit has been rotated on the touch display unit from a first position to a second position different from the first position to obtain a detection result.

16. The electronic device of claim 15, wherein an identification area is provided in the contact region, and
as the contact region is rotated from the first position to the second position, the identification area is rotated from a third position corresponding to the first position to a fourth position corresponding to the second position and different from the third position.

17. The electronic device of claim 15, wherein the contact region has a first reference line and a second reference line that does not coincide with the first reference line, and
as the contact region is rotated from the first position to the second position, the first reference line and the second reference line are rotated from a fifth position corresponding to the first position to a sixth position corresponding to the second position and different from the fifth position.

18. The electronic device of claim 17, wherein the first reference line is orthogonal to the second reference line.
